(19) United States
(12) Patent Application Publication
(10) Pub. No.: US 2026/0161666 A1
(43) Pub. Date: Jun. 11, 2026

(54) ENTITY RESOLUTION BASED ON IDENTITY GRAPHS AND NEURAL NETWORKS

(71) Applicant: MASTERCARD INTERNATIONAL INCORPORATED, Purchase, NY (US)

(72) Inventors: Wally F. LO FARO, St Louis, MO (US); Hasan HICSASMAZ, Iowa City, IA (US); Amanjit AHUJA, Pittsburgh, PA (US); Daniel WALD, Philadelphia, PA (US); Mohammad Mehdi KAFASHAN, Wildwood, MO (US); Prabin LAMICHHANE, O Fallon, MO (US); Arturo DEL VALLE, O Fallon, MO (US)

(73) Assignee: MASTERCARD INTERNATIONAL INCORPORATED, Purchase, NY (US)

(21) Appl. No.: 19/179,846

(22) Filed: Apr. 15, 2025

Related U.S. Application Data
(60) Provisional application No. 63/635,386, filed on Apr. 17, 2024.

(51) Int. Cl. G06F 16/28

(52) U.S. Cl. CPC G06F 16/285

(57) ABSTRACT

The disclosure relates to methods and systems of entity resolution based on identity graph enrichment, candidate match identification with blocking, feature generation based on similarity scores, and training and executing deduplication models to perform match classification on candidate matches. An entity graph may include transaction data originating from point-of-sale devices, which may be low quality data for entity resolution. The identity graph may be enriched with enrichment data and candidate matches with blocking may identify potentially duplicate merchant records. A deduplication models is trained and executed based on features from the identity graph to generate a match classification, in which a match indicates a duplicate merchant.

### RELATED APPLICATIONS

This application claims priority to U.S. Provisional Patent Application Ser. No. 63/635,386, entitled “ENTITY RESOLUTION BASED ON IDENTITY GRAPHS AND NEURAL NETWORKS,” filed on Apr. 17, 2024, which is incorporated by reference in its entirety herein.

### BACKGROUND

Computer systems may perform entity resolution to disambiguate an entity from other entities based on available data about the entities. Entity resolution is a process in which the computer system determines whether data pertains to a single entity. Thus, entity resolution can be used to identify unique entities from large datasets. For example, a computational system may access a plurality of data records relating to entities and perform entity resolution to identify unique entities. To do so, the computational system may compare an incoming data record about an entity and determine whether or not the incoming data record relates to an entity that is already known in a knowledgebase. If not, a new entity is generated and stored in the knowledgebase. If the incoming data relates to a known entity, the data record may be stored as part of the existing entity's data records without creating a record for a new entity. The particular types of entities and data records will vary depending on the context in which the computer system operates.

Regardless of the context, an entity resolution problem may arise when the data records are low quality such as being inconsistent, incomplete, or otherwise inaccurate. An example of an entity resolution problem is the existence of duplicate entities in the knowledgebase. A duplicate entity is a single entity that is stored in the knowledgebase as two or more unique entities. According to the knowledgebase, there are two or more unique entities even though the data records for these entities in fact relate to a single entity. Duplicate entities can present various issues such as duplicative storage and retrieval requirements and obfuscation of the true identity of the entity involved in the duplication. The nature of entity resolution problem may vary depending on the context in which the problem occurs. But in each context, an entity resolution problem will cause issues for downstream processes that rely on a correct entity resolution.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment 100 for entity resolution to deduplicate entity records based on graph schema expansion and identity graph enrichment, blocking, and machine learning classifiers trained on features based on identity anchors from the enriched identity graph;

FIG. 2 illustrates an example of an entity vertex of an identity graph and corresponding identity anchors;

FIG. 3 illustrates an example of edges between an entity vertex and identity anchors to illustrate a detected relationship between a vertex and identity anchor and/or relationships between identity anchors;

FIG. 4 illustrates an example of a portion of an enriched identity graph;

FIG. 5 illustrates an example of a processing flow of a deduplication model;

FIG. 6 illustrates an example of a method of performing entity resolution based on deduplication, blocking, and neural networks; and

FIG. 7 illustrates an example of a method of performing entity resolution in the context of merchant resolution to deduplicate a merchant database;

FIG. 8 illustrates an example of a method for detecting anomalous numbers of new merchants and preparing data records for duplication classification by the deduplication model;

FIG. 9 illustrates an example of a schematic data flow for detecting anomalous numbers of new merchants and preparing data records for duplication classification by the deduplication model; and

FIG. 10 illustrates an example of a computer system that may be implemented by devices illustrated in FIG. 1.

### DETAILED DESCRIPTION

The disclosure relates to methods and systems of entity resolution based on identity graph enrichment, candidate match identification with blocking, feature generation based on similarity scores, and training and executing deduplication models to perform match classification on candidate matches. For example, a system may generate an identity graph having vertices and edges that connect the vertices. A vertex may be an entity vertex or an identity anchor vertex. An entity vertex represents a presumptive unique entity. Entity resolution problems may cause multiple entity vertices to be wrongly created or stored for a single entity. An identity anchor vertex represents an identity anchor, which is data known about a corresponding entity that may be used to identify the entity or otherwise compare the entity with other entities based on their respective identity anchors.

To generate an identity graph, the system may access data records from various data sources. When new data records are ingested by the system, the system may determine whether an entity described in a data record is known to the system, such as when another data record associated with the entity was previously ingested. For example, the system may compare the data record to previously ingested data records and if there is a match, then the system determines that the entity is a known entity. If there is not a match, the system assumes that the entity is a new entity and stores the data record in association with a new entity identifier. The system may also update the identity graph. For example, the system may add a new entity vertex for a new entity (or believed to be new entity) associated with the data record.

However, the system may make a false negative match, which results in an entity resolution problem of a duplicate entry for the entity. In particular, the duplicate entry results in entity duplication in which different records for the same entity are stored as if the entity were two or more unique entities. To at least partially address this problem and to provide enriched data for further downstream solutions (such as candidate matching and match classification), the system may access enrichment data and enrich the identity graph based on the enrichment data. The enrichment data is additional data about entities and/or their relationships with other entities. To incorporate the enrichment data, the system may expand a graph schema, such as by adding a vertex type, an edge type, a graph property, or other graph schema characteristics. By using an expanded graph schema and enriched data, the system may fill in data gaps and add additional data types and relationships between the data for enhanced entity resolution processes that can occur downstream of identity graph creation.

To identify duplicate entities, the system may identify candidate matches. A candidate match is two or more entities (typically but not necessarily a pair of entities) that are potentially duplicates of one another by virtue of the similarity of one or more of their identity anchors and/or other data known about the entities. To identify candidate matches, the system would ordinarily perform an all-v-all pairwise comparison of first and second sets of entities being compared, which is a Cartesian product of the two sets. The system may identify candidate matches from among two sets of entities depending on the deduplication goal. For example, if the deduplication goal is to identify presumptively new entities that are actually duplicates of known entities, the first set of entities for comparison will be the new entities and the second set of entities for comparison will be the known entities. If the goal is to identify duplicates within all known entities, then the first set of entities and the second set of entities will each be all of the known entities (in which case the all-v-all comparison will be a self-comparison).

The nature of the Cartesian product for candidate match identification can be a computationally intensive operation, particularly when the number of entities in either or both sets being compared is high. Thus, an all-v-all comparison may not be practically possible. Even if practically possible, this comparison may not scale as new data is added. To address this issue, the system may identify candidate matches with a blocking process. A blocking process is a computational process that improves dataset filtering and reduces the complexity of the possible combinations of candidate matches to consider.

A blocking process may use one or more blocking keys. A blocking key has a data value that is likely to be similar in matching data records. Examples of blocking keys may include a zip code, a city, a state, and/or other data value that may be similar in two or more matching data records. The system may group the data records into blocks based on matching blocking keys. For example, the system may group data records having the same state, city, zip code, and/or other blocking key. Data records within a given block may have a higher likelihood of having matching data records than data records that span different blocks. Instead of comparing all possible combinations of potential matches across all available data, the system may compare data records within a given block based on a blocking key, thereby reducing the number of comparisons.

The blocking process may facilitate high recall that minimizes false negatives while attempting to maximize the number of true positives (actual matches). The blocking process may further facilitate high precision in which blocks do not grow too large to minimize intra-block comparisons. The system may use different types of blocking processes to iteratively reduce the number of possible combinations to consider. For example, the system may use standard blocking followed by sorted neighborhood blocking.

Once candidate matches are identified, the system may generate a match prediction for each candidate match. A match prediction is a prediction that indicates whether or not the candidate match is a genuine match and therefore a duplicate entity record that can be deduplicate. The match prediction may be generated by a deduplication model. The deduplication model is a supervised machine learning model that is trained on labeled training data to identify duplicate data records. The training data is labeled to indicate whether data records are genuine matches or not matched. For example, the training data may include data based on pairs of merchant vertices and their corresponding identity anchor vertices that are known to be matched and pairs of merchant vertices and their corresponding identity anchor vertices that are known to be not matched. As such, the deduplication model is trained to identify features of matched and not matched records.

The features may be based on similarity scores between various data values of the data records such as merchant names, addresses, city, state, zip code, URL, and/or other data known about the entities. For example, the features may be based on similarity of different identity anchors of an identity graph. Features that may be used include a Jaro-Winkler distance, a Levenshtein distance, Cosine similarity, and/or other similarity metrics.

The system may train the deduplication model based on training data that includes labeled pairs of data records in which a label indicates a match or non-match. For example, some pairs of data records are labeled as a match (duplicate corresponding to one entity) while other pairs of data records are labeled as a non-match (non-duplicate corresponding to two entities). Each data record of each pair may include identity anchors and/or other feature data.

The system may generate a feature vector for each labeled pair of data records. Thus, each pair of data records will have a corresponding feature vector, which is labeled according to a match or non-match of the underlying pair of data records. To generate the feature vector, the system may determine one or more of the similarity scores. Using similarity scores in feature vectors may be advantageous for various reasons, including flexibility, interpretability, and reduced feature dimensionality. For example, use of similarity scores in feature vectors may tolerate noisy data having variation or errors such as typographical errors or incomplete strings or data values in merchant POS data. Similarity scores are also easily understood by humans compared to more complex representations. Furthermore, using multiple similarity scores in a feature vector reduces feature dimensionality from multiple fields of data into a smaller set of similarity scores.

To train the deduplication model, the system may provide as input the feature vectors with labels to a classification algorithm. The classification algorithm may include decision trees or random forests, logistic regression, Support Vector Machines (SVM), a neural network, and/or other classification algorithms. The classification algorithm identifies patterns and relationships within the similarity score features that strongly correlate with a match classification (or non-match classification).

In operation after training, the deduplication model may generate a match prediction based on a candidate match. A candidate match is a possible match between at least two entities. The computer system may generate a feature vector for the entities in the candidate match as described with respect to generating feature vectors in the training data. The feature vector is provided as input to the deduplication model, which is trained to determine whether the feature vector corresponds to “match” labeled feature vectors in the training data or “non-match” labeled feature vectors in the training data. The match prediction may be a binary (match or non-match) classification. Based on the match prediction, the system may determine that the candidate match is a match or non-match. If the candidate match is a match, then the system may merge the data records of the two entities.

Entity resolution problems and the systems and methods described herein that address them may arise in various contexts, such as in network security to determine whether network events relate to the same actor or threat, healthcare systems to determine whether medical data relates to a single patient, fraud detection to determine whether seemingly disparate transaction relate to the same actor, among others. For illustration, various examples of entity resolution problems will be described herein in the context of performing entity resolution on merchants to determine whether transaction or other data relates to a single merchant.

In some examples, the system may identify micro-anomalies from merchant location data. For example, the system may identify a pattern of new merchant creation given different attributes (use cases). Generally speaking, if an acquirer usually creates 10 merchants each day over a training window, but on a given day, the acquirer created 1,000 new merchants, this would be anomalous behavior. In this case, the system may identify the anomaly and identify merchants created by that acquirer for deduplication models.

Having described an overview of examples of operation of entity resolution, attention will now turn to an example of a system environment in which entity resolution may be performed.

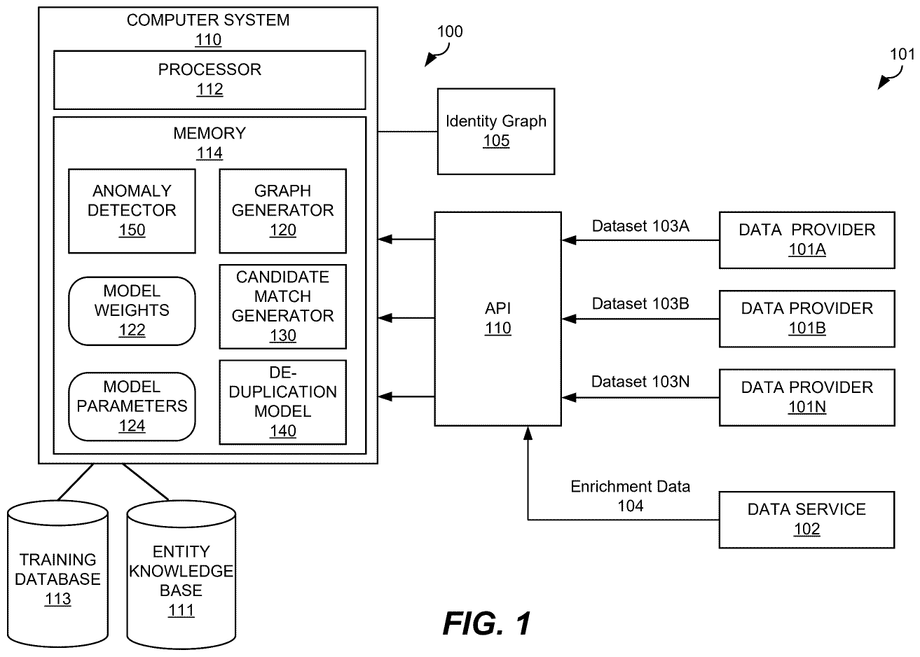

FIG. 1 illustrates an example of a system environment 100 for entity resolution to deduplicate entity records based on graph schema expansion and identity graph enrichment, blocking, and machine learning classifiers trained on features based on identity anchors from the enriched identity graph. The system environment 100 may include one or more data providers 101 (illustrated as data providers 101A-N), a computer system 110, and/or other components. At least some of the components of the system environment 100 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

A data provider 101 may provide data records 103, which may include one or more data elements. Each of these data elements may store a data field, such as an address, a name, and/or other data. The particular type of data record 103 will depend on the context in which the system environment 100 is implemented. For example, in the context of a payment card network, a data provider 101 may include a merchant (such as a merchant point of sale system), an acquirer that processes payments on behalf of the merchant, a third party data service, and/or other data sources. A data record 103 from a merchant or acquirer may be a transaction record based on an authorization request message. A data element in the data record 103 may include a merchant descriptor, transaction amount, transaction identifier, and/or other data about the merchant or transaction. Third party data providers may provide data records 103 that include information known about various entities, including merchants, such as addresses, contact information, and/or other data known about an entity.

The computer system 110 may include one or more computing devices that access the data records 103 and perform entity resolution. The one or more computing devices of the computer system 110 may each include a processor 112, a memory 114, a graph generator 120, a candidate match generator 130, a deduplication model 140, an anomaly detector 150, and/or other components.

The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

The graph generator 120, the candidate match generator 130, the deduplication model 140 may each be implemented as instructions that program the processor 112. Alternatively, or additionally, the graph generator 120, the candidate match generator 130, the deduplication model 140, and the anomaly detector 150 may each be implemented in hardware.

The graph generator 120 may access data records 103 from a data provider 101. Each data record 103 includes entity data that describes an entity and/or relationship of an entity with another entity. For example, the entity data may include a record identifier, one or more entity attributes, an entity identifier, and/or other data associated with an entity. The entity data will vary depending on the context in which the computer system 110 is implemented. For example, in the context of a payment card transaction, the record identifier may be a transaction identifier, entity attributes may describe a merchant (such as merchant address, phone number, or other attribute), and the entity identifier may be a merchant descriptor such as a name used by the merchant for processing payment card transactions. The merchant descriptor used to identify the merchant may vary over time, across different payment networks or acquirers, and/or for other reasons. Thus, a single merchant may be associated with different merchant descriptors, resulting in an entity resolution problem for card networks.

The graph generator 120 may generate and/or update an identity graph 105 based on the accessed data records 103. An identity graph 105 is a data structure that stores data about entities used to resolve their identities. In particular, the data structure may encode relationships between the data that may be used to identify a given entity. The identity graph 105 may include entity vertices, identity anchor vertices, and edges. Each entity vertex represents an entity for which entity resolution may be performed. Each entity vertex may be associated with one or more identity anchor vertices that each represent data about the entity. Each edge may connect a vertex (an entity vertex and/or identity anchor vertex) with another vertex. The connection represents a relationship between the connected vertices.

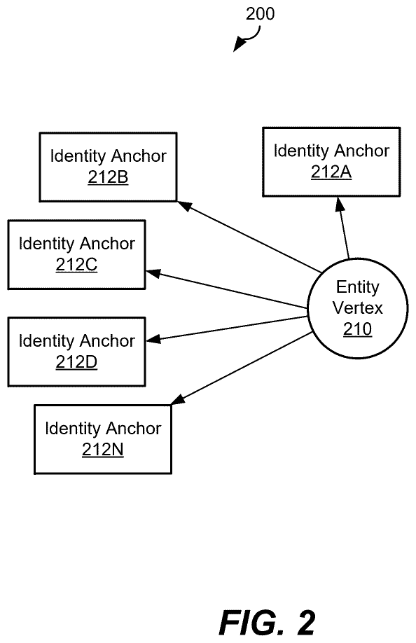

FIG. 2 illustrates an example 200 of an entity vertex 210 of an identity graph 105 and corresponding identity anchors 212 (illustrated as identity anchors 212A-N). An identity anchor 212 encodes an identity anchor, which is data about an entity that can be used to identify the entity and/or link the entity to another entity. An identity anchor may include a street address, a phone number, a string name such as a doing-business-as name that can vary for the same entity (such as when the entity is known by or otherwise provides different entity names), a uniform resource locator (URL) of the entity, an acquirer identifier that identifies an acquirer used by the entity, and/or other data that can be used to identify an entity.

In some instances, a given data record 103 used to generate an entity vertex 210 and its corresponding identity anchors 212 may not provide sufficient information to identify an entity. This can result from high dimensionality and the multi-variate nature of data records in which some data records include one set of data and other data records include other sets of data. For example, in a card network transaction, the quality of data from point of sale (“POS”) devices may vary depending on the particular POS system used, the acquirer entity used by the merchant entity, and/or the particular merchant entity that operates them. The foregoing may result in a data quality problem in which data about merchants is not consistently represented, is missing, changes over time, or has other problems. These or other data quality problems can lead to identity graphs 105 that are incomplete or duplicative. Training machine learning models, such as the deduplication model 140, based on these sparse identity graphs 105 may result in missed data and associations, model overfitting, and biased results, among other problems. To address this issue, the graph generator 120 may enrich the identity graph 105 with enrichment data 104 from a data service 102. The data service 102 may provide data about various entities that may overlap with, augment or otherwise be different than the data available in a data record 103. For example, an entity vertex 210 and its corresponding identity anchors 212 from a data record 103 from a POS device may be enriched with the enrichment data 104 from the data service 102.

### Graph Enrichment Based on an Expanded Graph Schema and Enrichment Data

In some examples, the graph generator 120 may enrich the identity graph 105 with enrichment data 104. To do so, the graph generator 120 may augment a graph schema to generate an expanded graph schema for the identity graph 105. A graph schema defines the types of vertices, edges, data properties and/or other aspect of an identity graph. Thus, a given identity graph 105 may be structured based on a graph schema.

Vertex types define the types of entities and/or type of identity anchors that are encoded by an identity graph 105. For example, for entities, the vertex types may include, without limitation, a merchant, a person, a product, an event, and/or other type of entity. For identity anchors, vertex types may include, without limitation, a street address, a phone number, a string name such as a doing-business-as name that can vary for the same entity (such as when the entity is known by or otherwise provides different entity names), a uniform resource locator (URL) of the entity, an acquirer identifier that identifies an acquirer used by the entity, and/or other data that can be used to identify an entity. Edge types define the types of relationships that may exist between vertices. An example of an edge type in the card network context is “a transaction occurred involving these vertices.” Other edge types may be used depending on the context in which the computer system is implemented. Properties may define attributes or characteristics associated with vertices or edges. Properties may therefore define the payloads of each vertex and/or edge.

The expanded graph schema may include new vertex types, edge types, properties, and/or other graph schema elements to accommodate the enrichment data 104, which may include additional identifying information. For example, if the enrichment data 104 includes a new type of identity anchor, that new type of identity anchor may be added to the identity graph 105, thereby providing a new type of data for entity resolution.

Doing so may provide a rich and new feature bed to enhance standard features for a deduplication model 140 that uses features such as string edit distance. Graph enrichment may further incorporate the additional identifying information at the front of the entity resolution process so that downstream resolution processes (such as candidate identification and deduplication modeling) may use this information. Graph enrichment may further simplify and scale the ingestion of additional identifying information from various sources. Graph enrichment may further provide a source of feature for improved downstream processes such as merchant aggregation.

For example, the graph generator 120 may generate some or all of the identity graph 105 based on data record 103A from a first data provider 101A. The graph generator 120 may then enrich the identity graph 105 based on additional data from one or more other data providers 101. For example, the graph generator 120 may enrich the identity graph 105 with data record 103B from a second data provider 101B. The graph generator 120 may further enrich the identity graph 105 with dataset 5103N from a second data provider 101N, and so on. Enriching the identity graph 105 with additional datasets may address data sparseness problems that may arise in data, such as in transaction data from merchants and/or acquirer, used to generate the identity graph 105.

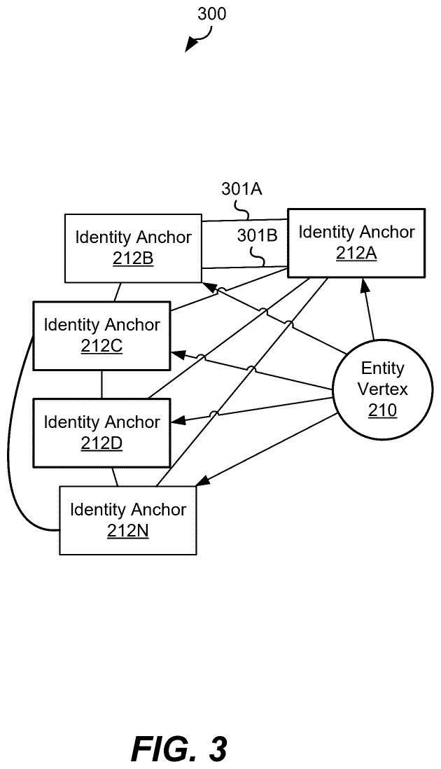

FIG. 3 illustrates an example 300 of edges 301 between an entity vertex 210 and identity anchors 212 to illustrate a detected relationship between a vertex and identity anchor and/or relationships between identity anchors. Edges 301 illustrate a relationship between different identity anchors 212. For instance, edge 301A may indicate that the identity anchor 212A and identity anchor 212B share a relationship. In the context of a card network transaction, the edge 301A indicates that identity anchor 212A and the identity anchor 212B were part of the same card transaction. In particular, if identity anchor 212A represents a doing-business-as (DBA) name and identity anchor 212B represents a merchant street address, edge 301A indicates that a transaction record has both the DBA name and the merchant street address. In this example, edge 301A represents information indicating that a given transaction involves a merchant entity having the DBA name and the merchant street address.

In some implementations, the number and/or magnitude of edges 301 between identity anchors 212 may indicate a relative strength of the relationship between identity anchors 212 or entity vertices 210. For example, edge 301B may be generated to represent another transaction involving the DBA name and the merchant street address. Alternatively, edge 301A may be given a weighted value to indicate the number of transaction records that have this pairing of DBA name and merchant street address. In either implementation, edges 301 may indicate a relationship and magnitude of the relationship between identity anchors 212.

It should be noted that the additional information may be accessed from third party sources in addition to or instead of transaction data records. For example, a third party business directory may provide DBA names and addresses of various entities, which may be used to enrich the identity graph 105 and its entity vertices 210 and/or identity anchors 212.

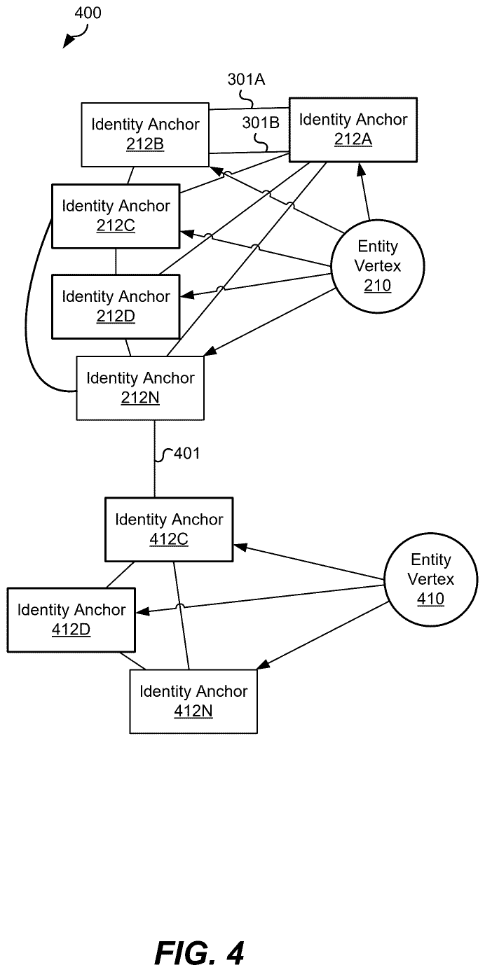

FIG. 4 illustrates an example 400 of a portion of an enriched identity graph 105. As illustrated, a candidate pair of entities may be identified based on one or more edges 401 between entity vertex 210 and entity vertex 410. In context of payment card transaction data, edges 401 represents the co-occurrence of an identity anchor 212 and an identity anchor 412 in a given transaction. For example, a transaction record for the given transaction may include a DBA name encoded in identity anchor 212A that has co-occurred with a URL encoded in the identity anchor 412N. Based on this and/or other edges 401 between identity anchors 212 and identity anchors 412, entity vertex 210 and entity vertex 410 may be identified as a candidate pair of entities. Other candidate pairs of entities may be similarly identified based on these comparisons.

### Candidate Match Identification

Whenever a new data record relating to an entity is received, entity resolution may be conducted to determine whether the new data record relates to a known entity already stored in the entity knowledgebase 111. If not, then a new entity is created for the data record in the entity knowledgebase 111. However, poor quality or otherwise incomplete data in the new data record may result in an entity resolution problem in which an entity is mistakenly determined to be a new entity not previously seen. This can result in various issues in the computer system, such as storing duplicate data records for an entity, contributing to overuse of storage systems. Other issues such as being unable to uniquely identify specific data records with a single entity can cause other problems. To address these and other problems, the candidate match generator 130 may identify candidate matches among new entities from newly accessed data records and known entities that are previously known and stored in the entity knowledgebase 111. A candidate match is a match between a new entity and a known entity. This match represents a possibility that the new entity and the known entity in the candidate match are, in fact, the same entity.

### Blocking to Reduce Complexity of the Cartesian Product

The number of possible combinations of candidate matches among the new entities and the known entities is a Cartesian product of the new and known entities. Thus, iterating through the number of possible combinations can be computationally intensive and practically not possible as the number of new entities and/or known entities grow. To address this issue, the candidate match generator 130 may use a blocking process that reduces the number of possible combinations. The blocking process is a computational process that improves dataset filtering and reduces the complexity of the possible combinations of candidate matches to consider.

The blocking process may use one or more blocking keys. A blocking key has a data value that is likely to be similar in matching data records. Examples of blocking keys may include a zip code, a city, a state, and/or other data value that may be similar in two or more matching data records. Based on the blocking process and one or more blocking keys, the candidate match generator 130 may group the data records into blocks based on matching blocking keys. Matches may be exact or similar. For example, the candidate match generator 130 may group data records having the same state, city, zip code, and/or other blocking key. Data records within a given block may have a higher likelihood of having matching data records than data records that span different blocks. For example, a pair of data records associated with the same zip code will have a higher probability of matching one another and therefore relate to the same entity than a pair of data records whose zip codes are different. Thus, instead of comparing all possible combinations of potential matches, the candidate match generator 130 may compare data records within a given block, thereby reducing the number of comparisons.

The blocking process may facilitate high recall that minimizes false negatives while attempting to maximize the number of true positives (actual matches). The blocking process may further facilitate high precision in which blocks do not grow too large to minimize intra-block comparisons.

To this end, in some implementations, the candidate match generator 130 may use various blocking keys and/or blocking techniques, such as standard blocking, multi-pass blocking, Soundex-based blocking, canopy clustering blocking, sorted neighborhood blocking, and/or other types of blocking techniques. Standard blocking performs exact matching on a single blocking key, such as described above in which data records having the same zip code and/or other blocking key are grouped into a block. Multi-pass blocking uses multiple blocking keys to create smaller, more precise blocks. Multi-pass blocking may therefore minimize intra-block comparisons (while creating higher numbers of blocks). Soundex-based blocking groups records based on phonetic representations of words within blocking keys, which may be used for blocking keys with strings such as names that may have spelling or typographical errors.

Canopy clustering blocking quickly generates overlapping blocks, which may be suitable for large datasets. Canopy clustering blocking uses first and second distance thresholds in which the first threshold is greater than the second threshold. Canopy clustering blocking generates an initial canopy by randomly selecting a data record from among the data records and iteratively assigning other data records to the initial canopy or a different canopy. To assign data records to the initial or different canopy, canopy clustering blocking may, for each canopy and each data record being assigned, calculate a distance from the data record being assigned to the center of the existing canopy. The distance may be a similarity score such as a string similarity score, a numeric similarity score, and/or other suitable similarity metric. If the distance is less than the first threshold, the data record is added to the canopy. If the distance is also less than the second threshold, this means the data record is tightly clustered within the canopy and can be removed. This process is repeated until each data record is assigned to an existing or new canopy.

Sorted neighborhood blocking sorts the data records based on a blocking key and generates overlapping blocks by taking a window having a predefined and/or configurable size to form blocks. The window size includes a number of consecutive records after sorting. Each window becomes a block. Windows may overlap one another. Thus, a given record may be included in multiple blocks. Comparisons are made only between records within the same block.

It should be noted that different blocking processes may be iterated to further reduce the number of possible combinations to consider. For example, the candidate match generator 130 may use standard blocking followed by sorted neighborhood blocking. Other combinations of blocking may be used as well or instead. The candidate match generator 130 may generate a set of candidate matches based on one or more of the blocking processes. Each candidate match may represent a duplicate entity record. To determine whether a candidate match is a genuine match, and therefore a duplicate entity record, the computer system 110 may train and use one or more deduplication models 140.

### Match Classification for Deduplication

A deduplication model 140 may take as input a candidate match and generate a match prediction 505, which is a prediction that indicates whether or not the candidate match is a genuine match and therefore a duplicate entity record that can be deduplicate. Deduplication is a process in which duplicate data records are merged to store only unique data or otherwise not stored separately in a duplicate manner. Deduplication reduces storage usage as well as reduces complexity for downstream processing of entities since fewer entity records are stored for downstream recall and analysis.

A deduplication model 140 is a supervised machine learning model that is trained on labeled training data to identify duplicate data records. The training data is labeled to indicate whether data records are genuine matches or not matched. For example, the training data may include data based on pairs of merchant vertices and their corresponding identity anchor vertices that are known to be matched and pairs of merchant vertices and their corresponding identity anchor vertices that are known to be not matched. As such, the deduplication model 140 is trained to identify features of matched and not matched records.

The features may be based on similarity scores between various data values of the data records such as merchant names, addresses, city, state, zip code, URL, and/or other data known about the entities. For example, the features may be based on similarity of different identity anchors of an identity graph 105. Features that may be used include a Jaro-Winkler distance, a Levenshtein distance, Cosine similarity, and/or other similarity metrics. The Jaro-Winkler distance places more importance at the beginning of the string such as for names, addresses, states, and other strings. The Levenshtein distance may place a higher importance on the order of characters, which may be suitable for street numbers, zip codes, and other data values in which the order of characters is important. Cosine similarity measures the similarity between two vectors by determining the angle between them. Smaller angles occur for more similar vectors. Identical vectors will have an angle of zero degrees. To generate a cosine similarity metric, the data records may be converted to numeric vectors. For example, one or more identity anchors may be converted to vectors via bag-of-words, term frequency inverse document frequency, N-grams, word embeddings, and/or other techniques for vectorizing data such as text. A dot product of the two vectors may be generated by summing corresponding products of elements in each vector and a magnitude of each vector may be determined. The cosine similarity metric may be determined by dividing the dot product by the product of the magnitudes.

### Training the Deduplication Model

The computer system 110 may train the deduplication model 140 based on training data from the training database 113. The training data may include labeled pairs of data records in which a label indicates a match or non-match. For example, some pairs of data records are labeled as a match (duplicate corresponding to one entity) while other pairs of data records are labeled as a non-match (non-duplicate corresponding to two entities). Each data record of each pair may include identity anchors and/or other feature data.

The computer system 110 may generate a feature vector for each labeled pair of data records. Thus, each pair of data records will have a corresponding feature vector, which is labeled according to a match or non-match of the underlying pair of data records. To generate the feature vector, the computer system 110 may determine one or more of the similarity scores described based on one or more identity anchors or other data known about the entities. For example, the computer system 110 may generate a first similarity score between DBA names in a pair of data records, a second similarity score between addresses in the pair of data records, and/or other similarity scores for other data in the pair of data records. The feature vector for this pair of data records will include the first similarity score, the second similarity scores, and/or other similarity scores determined for the other data in the pair of data records.

Using similarity scores in feature vectors may be advantageous for various reasons, including flexibility, interpretability, and reduced feature dimensionality. For example, use of similarity scores in feature vectors may tolerate noisy data having variation or errors such as typographical errors or incomplete strings or data values in merchant POS data. Similarity scores are also easily understood by humans compared to more complex representations. Furthermore, using multiple similarity scores in a feature vector reduces feature dimensionality from multiple fields of data into a smaller set of similarity scores.

To train the deduplication model 140, the computer system 110 may provide as input the feature vectors with labels to a classification algorithm. The classification algorithm may include decision trees or random forests, logistic regression, Support Vector Machines (SVM), a neural network, and/or other classification algorithms. The classification algorithm identifies patterns and relationships within the similarity score features that strongly correlate with a match classification (or non-match classification). Resulting model weights 122, model parameters 124 used, and/or other data from learning may be stored in the training database 113.

### Executing the Deduplication Model for Match Predictions

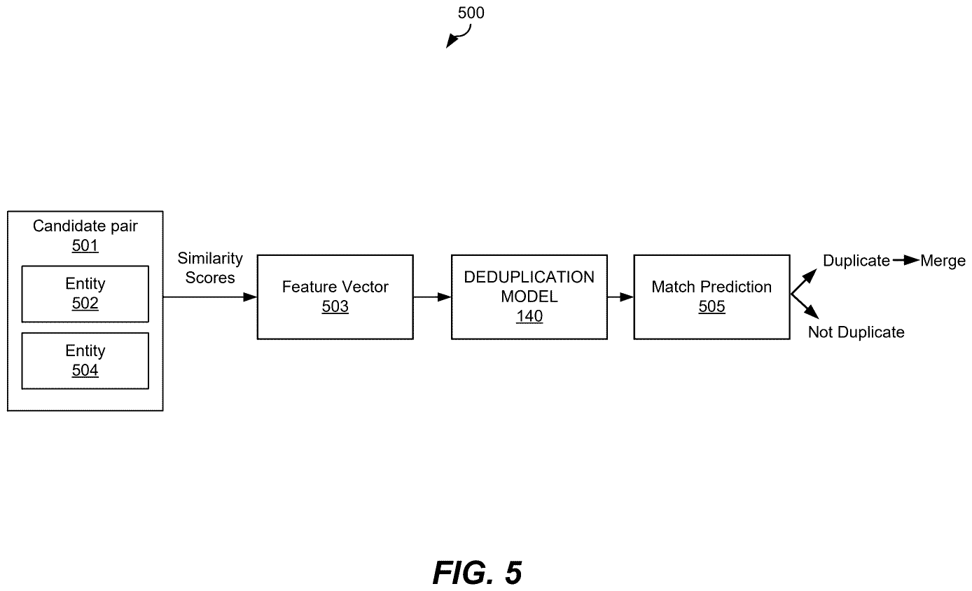

FIG. 5 illustrates an example of a processing flow 500 of a deduplication model 140. The deduplication model 140 may generate a match prediction 505 based on the candidate match 501. The candidate match 501 is a possible match between entities 502 and 504. Entity 502 and entity 504 each have associated identity anchors or other data known about the entities. The computer system 110 may generate a feature vector 503 for the entities 502 and 504 as described with respect to generating feature vectors in the training data, such as by generating one or more similarity scores for the identity anchors or other data known about the entities. The feature vector is provided as input to the deduplication model 140. The deduplication model 140 is trained to determine whether the feature vector 503 corresponds to “match” labeled feature vectors in the training data or “non-match” labeled feature vectors in the training data. Accordingly the deduplication model 140 may generate a match prediction, which is a prediction used to determine whether or not the candidate match 501 is a match or a non-match. For example, the match prediction 505 may be a binary (match or non-match) classification. Based on the match prediction 505, the computer system 110 may determine that the candidate match is 501 is a match or non-match. If the candidate match 501 is a match, then the computer system 110 may merge the data records of the entity 502 and entity 504. The computer system 110 may merge the data records of entity 502 with the data records of entity 504, or vice versa. Merging data records may include deleting identical (redundant) data records and/or adding a new data record. For example, if both entities 502 and 504 have an address data element and the addresses are identical, then merging may involve deleting one of the addresses so that only one address is stored. If both entities 502 and 504 have an address data element and the addresses are different, then merging may involve deleting one of the addresses so that only one address is stored or storing both of the addresses to retain both. If entity 502 has a URL data field and entity 504 does not, merging may involve retaining the URL data field for entity 502 (if entity 504 is merged into entity 502) or adding the URL data field to the data record of entity 504 (if entity 502 is merged into entity 504).

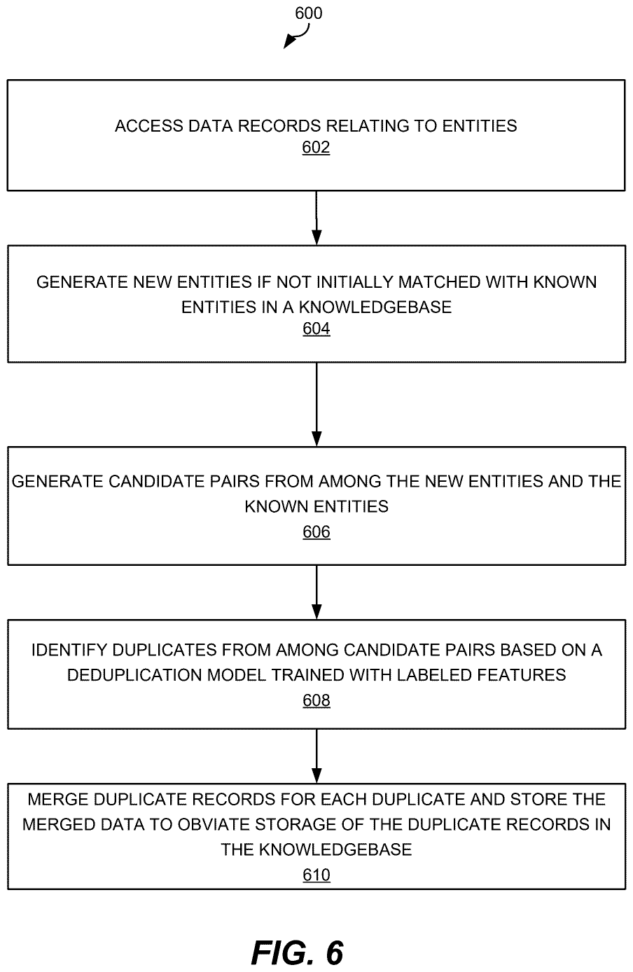

FIG. 6 illustrates an example of a method 600 of performing entity resolution based on deduplication, blocking, and deduplication classification.

At 602, the method 600 may include accessing a plurality of data records (such as data records 103) and an identity graph (such as identity graph 105). At 604, the method 600 may include updating the identity graph based on the plurality of data records. At 606, the method 600 may include clustering, via a blocking process, the plurality of entities and the plurality of known entities into two or more blocks based on the plurality of data elements and the data for the plurality of known entities. The blocking process reduces a number of possible matches between the plurality of entities and the plurality of known entities, the number of possible matches being a cartesian product of the plurality of entities and the plurality of known entities.

At 608, the method 600 may include identifying, for each block from among the two or more blocks, candidate pairs of entities in which each candidate pair includes an entity in the block from among the plurality of entities and a known entity in the block from among the plurality of known entities. At 610, the method 600 may include generating one or more features based on the plurality of data elements. At 612, the method 600 may include for each candidate pair, generating, by a deduplication model trained based on the one or more features, an output indicating whether the candidate pair matches, wherein a match indicates that the candidate pair is a duplicate.

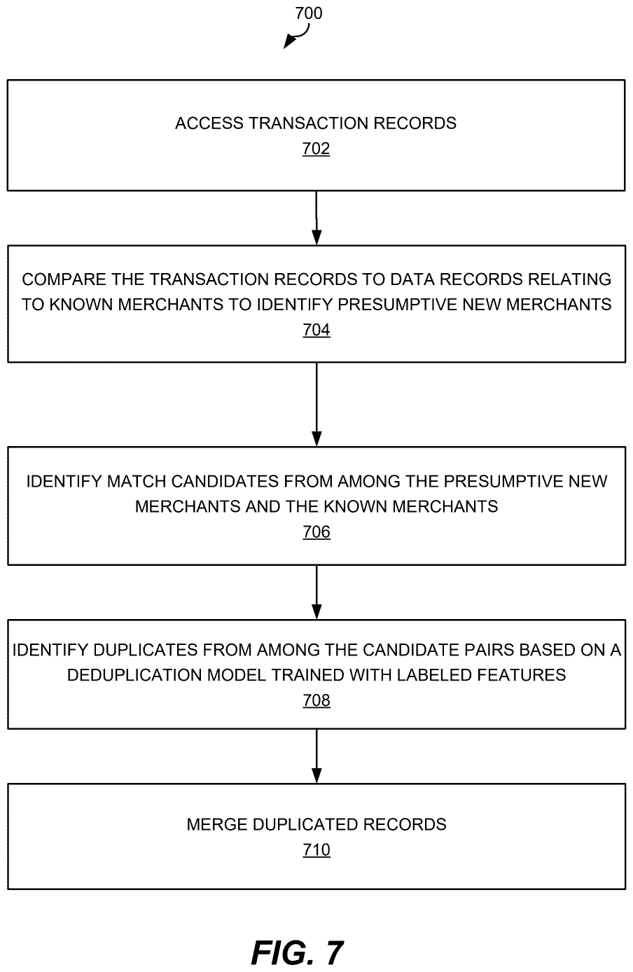

FIG. 7 illustrates an example of a method 700 of performing entity resolution in the context of merchant resolution to deduplicate a merchant database.

At 702, the method 700 may include accessing transaction records. At least some of the transaction records originate from a POS device in connection with a card network transaction initiated by a merchant or its acquirer. The transaction record may include transaction data such as a merchant descriptor, an address, a phone number, payment amount and/or other data about a merchant that may appear on a cardholder statement. The types of data included in the transaction record will vary depending on the POS device, merchant and/or acquirer. Furthermore, the data may change over time. For example, a merchant may change an address if the merchant has moved. Other data problems may arise such as when a merchant chain presents different data for different locations. An identity graph (such as the identity graph 105, which may be generated, updated, and enriched by the graph generator 120) may be updated based on the transaction records.

At 704, the method 700 may include comparing data elements in each transaction record with a merchant database of known merchants to identify presumptive new merchants. A presumptive new merchant is a merchant that is not believed to exist in the merchant database. These merchants are presumed to be new, but aren't necessarily new because they may be duplicates of known entities due to entity resolution problems.

At 706, the method 700 may include identifying match candidates from among the presumptive new entities and the known entities. Match candidate identification may be performed as described with respect to the candidate match generator 130. At 708, the method 700 may include identifying any duplicates from among the candidate pairs based on a classification model, such as the deduplication model 140. At 710, the method 700 may include merging the duplicate records. Such merging may reduce storage requirements as well as correctly identify merchants.

### Anomaly Detection for Deduplication Classification

In some examples, the anomaly detector 150 may detect anomalies that suggest duplicate entities are being newly created. In some of these example, the anomalies detected by the anomaly detector 150 may identify presumptive new entities that are actually duplicates of known entities. As such, the anomalies detected by the anomaly detector 150 may be converted into machine-learning format (such as via hot encoding) for classification by the de-duplication model 140.

The anomaly detector 150 may identify an anomalous number of newly added merchant locations (which are presumptive new merchants), which may be broken down by use case. A use case is a specification of how to detect an anomalous number of newly added merchant locations according to one or more use case attributes, such as Interbank Card Association (ICA), region, merchant type, etc.).

A merchant location indicates a location from which a transaction occurred or was originated. Merchant locations my include a single physical store, a branch, and/or point-of-sale terminal. A merchant may have multiple merchant locations, such as when the merchant has a chain of stores. Each merchant location may be identified by a unique merchant location identifier. Each merchant location may be associated with a merchant identifier (ID) that uniquely identifies a merchant, a terminal ID that identifies the point-of-sale terminal, and/or an acquirer ID that identifies an acquirer that processes transactions on behalf of the merchant. In some examples, merchant locations may be associated with virtual locations, such as a website domain, an Internet Protocol address, a registered business address, a virtual terminal ID, and/or other information relating to a virtual business location.

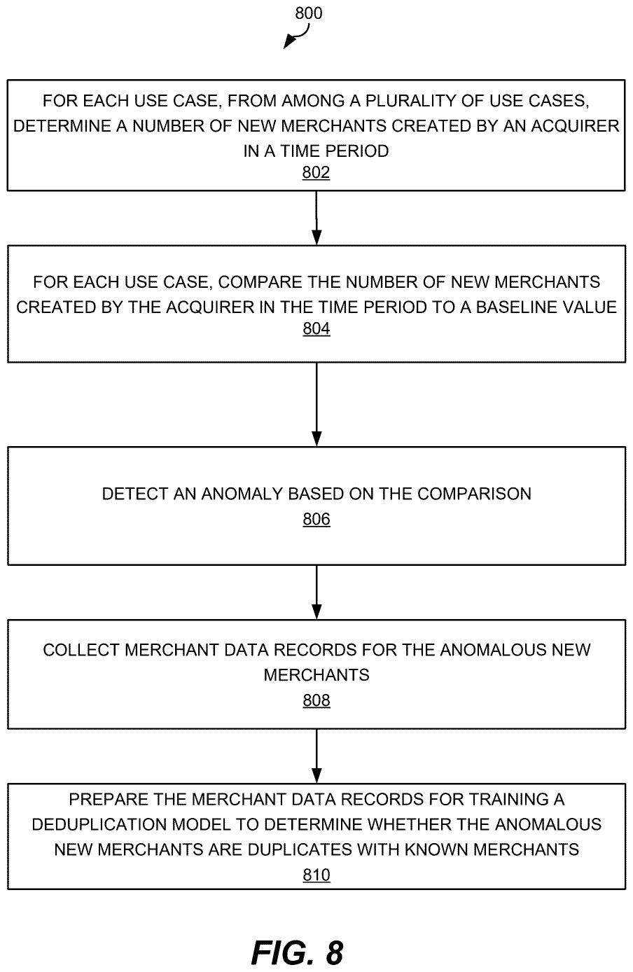

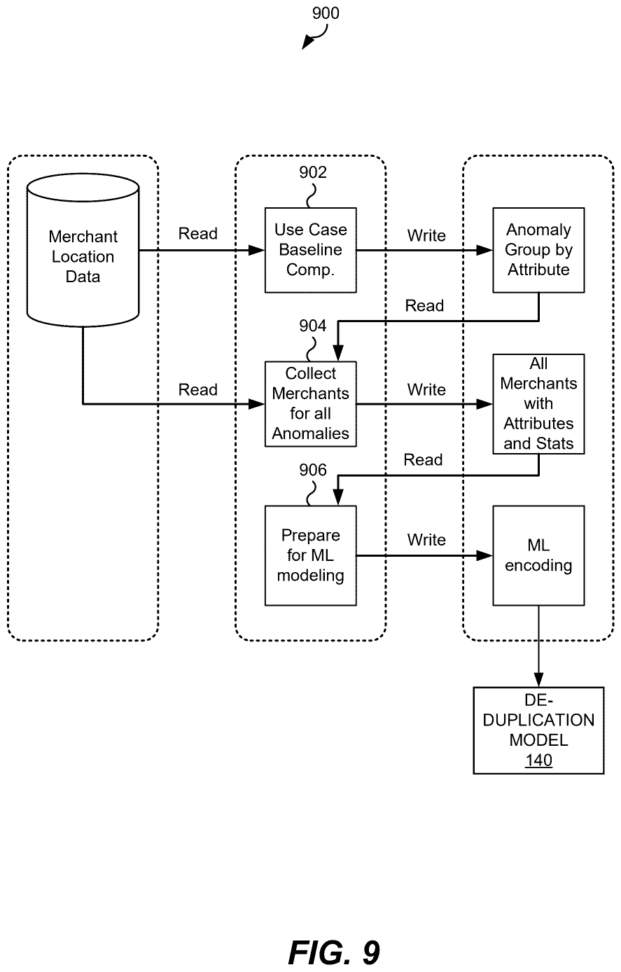

Table 1 below shows examples of use cases for illustration, and FIGS. 8 and 9 illustrates examples of methods of detecting anomalies based on these and/or other use cases.

TABLE 1
Illustrative examples of use cases for which anomalies are to be detected.

| Use Case Description | Metrics |
|---|---|
| Identify anomalous increase in number of | # Locations/ICA |
| locations created by a specific ICA in a day | |
| Identify anomalous increase in number of location | # Locations/(DBA + STREET + |
| created by combination of Identity | TAX_ID + ACQ_MERCH_ID) |
| Locations with excessive Acquirer Masters | mmh_location_acquirer_master\ |
| | no historical NO statistical measures -- |
| | SCIENTIST NOT NECESARY |
| Store-level Tax IDs with multiple locations (i.e., | # Locations/TaxID |
| Brazil) | |
| Third-Party identifiers (D + B, ZoomInfo, POI, | #Locations/POIID and |
| etc.) with multiple locations | #Locations/DUN_BRADSTREET_NBR |
| | NOTE: These are 3 separate groups, we |
| | have DB and POI |
| New Locations by MCC/ICA/CC/ST with | # Locations/(MCC + ICA + CC + ST) |
| multiple locations in any combination | |
| Merchant Street Addresses with multiple locations | # Locations/ |
| | MERCHANT_STREET_ADDRESS |
| Acq Merchant IDs with multiple locations | # Locations/ |
| | (ICA_CODE + ACQ_MERCHANT_ID) |
| Acq Merchant + Submerchant ID combinations | # Locations/(ACQ_MERCH_ID + |
| with multiple locations | PAYFAC) |
| Locations with multiple Short DBA Prefixes | # LOCATIONS/ |
| | substr(SHORT_DBA_NAME, 1, 3) |
| Locations with excessive Derived Masters | mmh_location_derived_master\ |
| | no historical NO statistical measures-- |
| | SCIENTIST NOT NECESARY |

FIG. 8 illustrates an example of a method 800 for detecting anomalous numbers of new merchants and preparing data records for duplication classification by the deduplication model 140. The method 800 may be executed by the anomaly detector 150 to detect anomalous new merchant locations, which may be per use case.

At 802, the method 800 may include, for each use case, from among a plurality of use cases, determine a number of new merchants created by an acquirer in a time period.

At 804, the method 800 may include, for each use case, comparing the number of new merchants created by the acquirer in the time period to a baseline value. The baseline value may be an average across a historical time period, such as the last 180 days, rolling averages, weekday seasonality, and/or standard deviations.

At 806, the method 800 may include detecting an anomaly based on the comparison. Detecting an anomaly may include determining a statistical distance between the observed number (from 802) and the baseline value.

At 808, the method 800 may include collecting merchant data records for the anomalous new merchants. At 810, the method 800 may include preparing the merchant data records for training a deduplication model to determine whether the anomalous new merchants are duplicates with known merchants. For example, each the merchant data records associated with the newly added merchant locations determined to be anomalous may be converted into feature vectors using the identity anchors described herein. Once vectorized, the data may be classified by the deduplication model 140.

FIG. 9 illustrates an example of a schematic data flow for detecting anomalous numbers of new merchants and preparing data records for duplication classification by the deduplication model.

At 902, the anomaly detector 150 may identify anomaly groups from a time period by reading data from merchant location data (which may be derived from transaction data from a payment network). In some examples, the time period is a day, in which case the anomaly detector 150 may execute 902 on a daily basis using the prior day's merchant location data. At 902, the anomaly detector 150 may collect relevant combinations of attributes of the merchant location data that indicate a potential new merchant location. For example, the anomaly detector 150 may use each combination of attributes as a fingerprint that identifies a unique merchant location that is counted for the collected time period (such as a day). In other words, each fingerprint may be counted as a new merchant location for the day for comparison to historical data to identify anomalies.

After identifying anomaly groups, the anomaly detector 150 may write (generate) an output: anomaly group by attribute, which may be a file and/or other output. Table 2 shows an example of the data in the output.

Table 2 is an example of attribute combinations.

| Column | Description |
|---|---|
| CC_ICA | Number of new locations were created using the |
| | same COUNTRY_CODE + ICA_CODE. High |
| | volume may suggest a mass boarding by one |
| | acquirer. |
| CC_TAXID | Tracks COUNTRY_CODE + TAXID. If multiple |
| | merchants share the same Tax ID, this may |
| | indicate a duplicate. |
| CC_STREET | COUNTRY_CODE + |
| | MERCHANT_STREET_ADDRESS. Multiple |
| | use of the same address may indicate a duplicate. |
| CC_POIID | Same POI ID + country. |
| CC_DNBNR | Multiple merchants with same DUNS may |
| | indicate a potential duplicate. |
| CC_SHORTDBAPREFIX | Tracks same first 3 letters of |
| | SHORT_DBA_NAME + country. To mitigate |
| | variation in names (such as “ABC co.” and “ABC |
| | company”). |
| CC_ICA_ACQMERCHID | Same COUNTRY_CODE + |
| | ACQ_MERCHANT_ID. may indicate copies of a |
| | merchant set up by an acquirer. |
| CC_ICA_ST_MCC | Combination of COUNTRY_CODE, |
| | ICA_CODE, STATE_PROVINCE_CODE, and |
| | MCC_CODE. Intends to identify regional |
| | clustering patterns. |
| CC_DBA_STREET_TAX_ACQMERCHID | Complex match on COUNTRY_CODE + DBA + |
| | Tax ID + Acquirer Merchant ID. This is a signal |
| | for near-exact duplicates. |

Table 3 shows examples of derived data from comparisons of the test data (such as yesterday's data) versus the training window data (such as historical 180-day period).

| Data | Description |
|---|---|
| DC_TRAIN_DATES | How many unique days this combination appeared over a training |
| | window (such as 180 days). Indicates pattern consistency. |
| DC_TEST_DATES | How many days the combination appeared in the test time period |
| | (such as yesterday's data). Detects whether combination is new. |
| AVG_TRAIN_CT | Average number of new locations created for the combo over the |
| | training period. Establishes an expected baseline. |
| AVG_TEST_CT | Average from the test period (such as yesterday's data). |
| | Observed behavior. |
| SDEV_TRAIN_CT | Standard deviation of counts in the training window. |
| | Mya be used for determining anomaly thresholds. |
| AVG_COUNT_DIFF | Difference between yesterday and average. This provides a raw spike |
| | magnitude value. |
| Z_SCORE | Statistical anomaly score (Z-score or Poisson variant). This anomaly |
| | score prioritizes significant anomalies in which higher scores are more |
| | anomalous than lower scores. |
| NOTE | If combination values are blank, this combination is newly seen for |
| | the first time. New combos with >2 locations are potentially |
| | anomalous. |

At 904, the anomaly detector 150 may collect anomaly merchants identified at 902. In particular, the anomaly detector 150 may read the output, Anomaly Group by Attribute. The anomaly detector 150 may, for each anomaly group in the output identified at 902, extract merchant records from the merchant location data that share the same anomalous attribute values as those in the output. These records may be grouped into anomaly groupings based on their shared attributes and written to the All Merchants with Attributes and Stats output.

At 906, the anomaly detector 150 may prepare the output of 904 for machine learning modeling. For example, the anomaly detector 150 may read the output of 904, augment the data with Hot-Encoding columns, and write an ML encoding output for use by the deduplication model 140. In particular, the anomaly detector 150 may generate 3-column sets for each anomaly type: 1-column for AI-Score (None for never been seen or otherwise for historical score), 1-column (binary 0 or 1) for what Use-Case from Overview, and 1-column for Use-Case ANOMALY group seen on the day (yesterday). In some examples, not illustrated, the anomaly detector 150 may generate a data report for review.

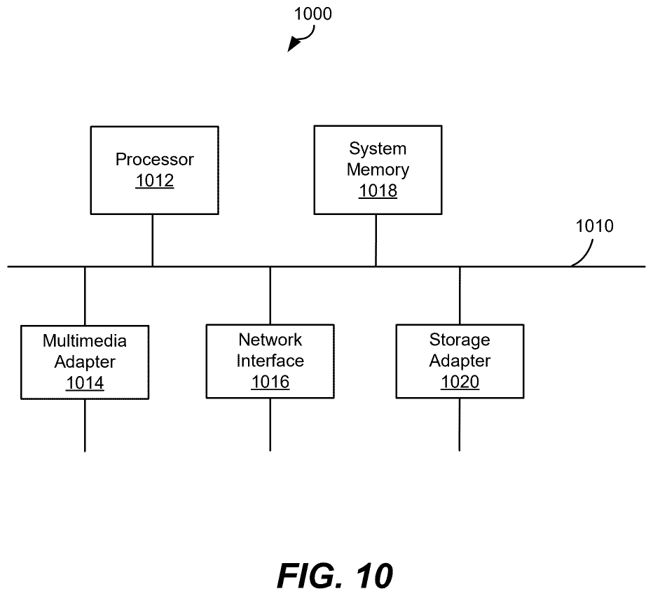

FIG. 10 illustrates an example of a computer system 1000 that may be implemented by devices illustrated in FIG. 1. The computer system 1000 may be part of or include the system environment 100 to perform the functions and features described herein. For example, various ones of the devices of system environment 100 may be implemented based on some or all of the computer system 1000.

The computer system 1000 may include, among other things, an interconnect 1010, a processor 1012, a multimedia adapter 1014, a network interface 1016, a system memory 1018, and a storage adapter 1020.

The interconnect 1010 may interconnect various subsystems, elements, and/or components of the computer system 1000. As shown, the interconnect 1010 may be an abstraction that may represent any one or more separate physical buses, point-to-point connections, or both, connected by appropriate bridges, adapters, or controllers. In some examples, the interconnect 1010 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 1010 may allow data communication between the processor 1012 and system memory 1018, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 1012 may control operations of the computer system 1000. In some examples, the processor 1012 may do so by executing instructions such as software or firmware stored in system memory 1018 or other data via the storage adapter 1020. In some examples, the processor 1012 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 1014 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 1016 may provide the computer system 1000 with an ability to communicate with a variety of remote devices over a network. The network interface 1016 may include, for example, an Ethernet adapter, a Fibre Channel adapter, and/or other wired- or wireless-enabled adapter. The network interface 1016 may provide a direct or indirect connection from one network element to another, and facilitate communication between various network elements.

The storage adapter 1020 may connect to a standard computer readable medium for storage and/or retrieval of information, such as a fixed disk drive (internal or external).

Other devices, components, elements, or subsystems (not illustrated) may be connected in a similar manner to the interconnect 1010 or via a network. The devices and subsystems can be interconnected in different ways from that shown in FIG. 10. Instructions to implement various examples and implementations described herein may be stored in computer-readable storage media such as one or more of system memory 1018 or other storage. Instructions to implement the present disclosure may also be received via one or more interfaces and stored in memory. The operating system provided on computer system 1000 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as 111) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
access a plurality of data records and an identity graph, each data record comprising a plurality of data elements for a respective entity from among a plurality of entities and wherein the identity graph comprises data for a plurality of known entities;
update the identity graph based on the plurality of data records;
cluster, via a blocking process, the plurality of entities and the plurality of known entities into two or more blocks based on the plurality of data elements and the data for the plurality of known entities, wherein the blocking process reduces a number of possible matches between the plurality of entities and the plurality of known entities, the number of possible matches being a cartesian product of the plurality of entities and the plurality of known entities;
identify, for each block from among the two or more blocks, candidate pairs of entities in which each candidate pair includes an entity in the block from among the plurality of entities and a known entity in the block from among the plurality of known entities;
generate one or more features based on the plurality of data elements; and
for each candidate pair, generate, by a deduplication model trained based on the one or more features, an output indicating whether the candidate pair matches, wherein a match indicates that the candidate pair is a duplicate.

2. The system of claim 1, wherein to update the identity graph, the processor is further programmed to:
for each data record from among the plurality of data records:
transform the plurality of data elements into a plurality of identity anchors, wherein each identity anchor comprises identifying data about an entity to which data record relates; and
link the plurality of identity anchors to an entity vertex corresponding to an entity to which the data record relates.

3. The system of claim 1, wherein the identity graph is structured based on a graph schema, wherein the processor is further programmed to:
access enrichment data comprising at least one new type of edge and/or at least one new type of vertex;
augment the graph schema based on the at least one new type of edge and/or at least one new type of vertex; and
enrich the identity graph based on the enrichment data and the augmented graph schema.

4. The system of claim 3, wherein the processor is further programmed to:
generate one or more new features based on the enrichment data; and
retrain the deduplication model based on the one or more new features.

5. The system of claim 1, wherein the one or more features comprises a similarity metric.

6. The system of claim 5, wherein the similarity metric comprises a Jaro-Winkler distance, a Levenshtein distance, and/or a Cosine similarity.

7. The system of claim 1, wherein the processor is further programmed to:
for each candidate pair determined to be a match, merge the data records for the candidate pair.

8. The system of claim 7, wherein the processor is further programmed to:
store only the merged data records in association with a single entity of the candidate pair.

9. The system of claim 1, wherein to cluster the plurality of entities and the plurality of known entities, the processor is further programmed to:
access one or more blocking keys, wherein each blocking key comprises a data value from among the plurality of data elements;
within each block from among the two or more blocks, compare a value of a blocking key for a first entity in the block with a value of a blocking key for a second entity in the block; and
group the first entity and the second entity based on the comparison.

10. The system of claim 9, wherein the one or more blocking keys comprises a city, a state, and/or a zip code.

11. The system of claim 1, wherein the processor is further programmed to:
determine, based on the plurality of data records, that the plurality of entities are potentially newly created entities;
compare a number of the potentially newly created entities to a baseline; and
determine that the number of the potentially newly created entities is anomalous based on the comparison, wherein the identify graph is updated based on the plurality of data records responsive to the determination that the number of the potentially newly created entities is anomalous.

12. A method, comprising:
accessing, by a processor, a plurality of data records and an identity graph, each data record comprising a plurality of data elements for a respective entity from among a plurality of entities and wherein the identity graph comprises data for a plurality of known entities;
updating, by the processor, the identity graph based on the plurality of data records;
clustering, by the processor, via a blocking process, the plurality of entities and the plurality of known entities into two or more blocks based on the plurality of data elements and the data for the plurality of known entities, wherein the blocking process reduces a number of possible matches between the plurality of entities and the plurality of known entities, the number of possible matches being a cartesian product of the plurality of entities and the plurality of known entities;
identifying, by the processor, for each block from among the two or more blocks, candidate pairs of entities in which each candidate pair includes an entity in the block from among the plurality of entities and a known entity in the block from among the plurality of known entities;
generating, by the processor, one or more features based on the plurality of data elements; and
for each candidate pair, generating, by the processor executing a deduplication model trained based on the one or more features, an output indicating whether the candidate pair matches, wherein a match indicates that the candidate pair is a duplicate.

13. The method of claim 12, wherein updating the identity graph, comprises:
for each data record from among the plurality of data records:
transforming the plurality of data elements into a plurality of identity anchors, wherein each identity anchor comprises identifying data about an entity to which data record relates; and
linking the plurality of identity anchors to an entity vertex corresponding to an entity to which the data record relates.

14. The method of claim 12, wherein the identity graph is structured based on a graph schema, the method further comprising:
accessing enrichment data comprising at least one new type of edge and/or at least one new type of vertex;
augmenting the graph schema based on the at least one new type of edge and/or at least one new type of vertex; and
enriching the identity graph based on the enrichment data and the augmented graph schema.

15. The method of claim 14, further comprising:
generating one or more new features based on the enrichment data; and
retraining the deduplication model based on the one or more new features.

16. The method of claim 12, wherein the one or more features comprises a similarity metric.

17. The method of claim 16, wherein the similarity metric comprises a Jaro-Winkler distance, a Levenshtein distance, and/or a Cosine similarity.

18. The method of claim 12, further comprising:
for each candidate pair determined to be a match, merging the data records for the candidate pair.

19. The method of claim 12, wherein clustering the plurality of entities and the plurality of known entities comprises:
accessing one or more blocking keys, wherein each blocking key comprises a data value from among the plurality of data elements;
within each block from among the two or more blocks, comparing a value of a blocking key for a first entity in the block with a value of a blocking key for a second entity in the block; and
grouping the first entity and the second entity based on the comparison.

20. A non-transitory computer readable medium storing instructions that, when executed by a processor, programs the processor to:
access a plurality of data records and an identity graph, each data record comprising a plurality of data elements for a respective entity from among a plurality of entities and wherein the identity graph comprises data for a plurality of known entities;
update the identity graph based on the plurality of data records;
cluster, via a blocking process, the plurality of entities and the plurality of known entities into two or more blocks based on the plurality of data elements and the data for the plurality of known entities, wherein the blocking process reduces a number of possible matches between the plurality of entities and the plurality of known entities, the number of possible matches being a cartesian product of the plurality of entities and the plurality of known entities;
identify, for each block from among the two or more blocks, candidate pairs of entities in which each candidate pair includes an entity in the block from among the plurality of entities and a known entity in the block from among the plurality of known entities;
generate one or more features based on the plurality of data elements; and
for each candidate pair, generate, by a deduplication model trained based on the one or more features, an output indicating whether the candidate pair matches, wherein a match indicates that the candidate pair is a duplicate.
